(19) United States
(12) Patent Application Publication
(10) Pub. No.: US 2010/0012441 A1
(43) Pub. Date: Jan. 21, 2010

(54) Play-free drive for an electromechanical brake device

(76) Inventors: Christian Baier-Welt, Ober-Ramstadt (DE); Martin Schautt, Munchen (DE)

Correspondence Address: King & Spalding LLP, 401 Congress Avenue, Suite 3200, Austin, TX, 78701, US

(21) Appl. No.: 12/443,476

(22) PCT Filed: Sep. 13, 2007
(86) PCT No.: PCT/EP2007/059665

§ 371 Date: Aug. 6, 2009

(30) Foreign Application Priority Data
Sep. 28, 2006 (DE) 10 2006 046 030.8

(51) Int. Cl. F16D 55/46; B62D 7/16

(52) U.S. Cl. 188/72.7; 403/42

(57) ABSTRACT

The invention relates to a coupling device for transmitting a linear movement of a drive (2, 8) to a wedge plate (3) of an electromechanical wedge brake, wherein the coupling device comprises at least one fixed-body element (1) with a first end designed for fastening to the drive and with a second end designed for fastening to the wedge plate, and the fixed-body element (1) has a first or a plurality of first regions (1a, 1b) with a cross section whose extent in a first direction is significantly smaller than its extent in a second direction which is arranged substantially perpendicular to the first direction.

The invention relates to an electromechanical wedge brake. The invention relates in particular to the transmission of forces between an actuator and an active wedge plate of a self-energizing electromechanical wedge brake.

In conventional disk brakes, the development of a braking moment is based on the direct generation of a large clamping force between two or more brake pads. In self-energizing electromechanical wedge brakes, the force applied to the brake, on the other hand, is lower than the achieved clamping force.

The force is applied in this type of brake by an electric motor which displaces a brake pad embodied as an active wedge plate. The brake pad is generally supported by means of a rolling bearing on a second, passive wedge plate such that its displacement guides it obliquely to the object to be braked, for example a brake disk. If the brake pad is guided in the direction of travel of the object to be braked to this object, then it is carried along by this object in the direction in which it is moving. If the inclination of the wedge surfaces fashioned on the wedge plates is suitable, the friction member, by this being carried along, is pulled further toward the object to be braked, as a result of which the braking effect of the electric motor functioning as an actuator is increased. This effect is generally known as self-energization. A mathematical treatment of the self-energization effect is described, for example, in patent specification EP 0 953 785. According to this, the force F_{M} to be applied to the wedge arrangement by the electric motor for a defined braking force F_{B}—that is the frictional force produced on the friction member—is lowered in accordance with the equation:

F_{M}=F_{B}·[(tan α−μ)/μ]; (1)

where α describes the angle of the wedge surface with the movement plane and μ signifies the friction coefficient for the material pair: friction lining/surface of the object to be braked.

From equation (1), the self-energization factor C* of the wedge brake emerges as:

C*=F_{B}/F_{M}=μ/(tan α−μ);

For (tan α-μ)>0, C* assumes positive values. The electric motor serving as a brake actuator therefore has to summon a displacement force which guides the brake pad to the object to be braked. Consequently, a push situation applies.

For (tan α−μ)<0, C* assumes negative values. The electric motor serving as a brake actuator therefore has to summon a displacement force which guides the brake pad away from the object to be braked. Consequently, a pull situation applies.

For (tan α−μ)=0, C* assumes no defined value.

In order reliably to prevent a locking of the brakes, the wedge brake would therefore have to be operated in accordance with equation (2) at a sufficient interval below the asymptote characterized by the critical value of μ=tan α. The achievable self-energization of the wedge brake would, however, be low as a result. In practice, however, it has been shown that even when the critical value of μ=tan α is reached, no absolute locking of the wedge brake occurs.

The fact that the brake is not in practice locked when passing from the push to the pull situation is due to the control arrangement used and to the inertias in the transmission of forces between the object to be braked and the electric motor serving as a brake actuator. Control of the braking force is effected with the aid of the electric motor serving as an actuator. This electric motor effects the displacement of the active wedge plate to a position in which a clamping force, determined substantially by the position of the wedge plates relative to one another and the spring effect of the brake caliper, is generated. When the desired value of the clamping force is reached, it is not the position of the active wedge plate that changes, but the force F_{M} to be applied by the actuator. In the control loop used for electromechanical wedge brakes, the force control of a conventional brake actuator is augmented by a speed or position control of the drive for the active wedge plate, this control changing the rotational speed of the electric motor such that the position of the wedge plates which corresponds to the desired value of the clamping force is set and retained. If the desired value of the clamping force is reached accordingly, the speed regulator of the control arrangement receives the desired value “zero”. It thus holds the position of the wedge plate constant even when the lining friction value p or the force FB oscillates.

Operation of the wedge brake around the operating point characterized by the asymptote of C* is thereby possible in practice. Since in this range very high self-energization of the wedge brake occurs, the brake can be operated with very low forces to be applied by the brake actuator.

However, the direction of the force to be applied by the actuator is reversed each time the asymptote is crossed. It must therefore be possible for the force to be applied by the electric motor of the actuator to the wedge brake arrangement to be controlled bidirectionally, the control having, due to the bidirectionality and the high dynamics of the system, to be implemented in accordance with equation (2) with an adequately short response time.

A corresponding dynamic bidirectional control causes, under operating conditions of the brake around the operating point characterized by (tan μ−α)=0, an oscillating action of force upon a coupling mechanism required for the transmission of force between brake actuator and active wedge plate. In order to enable a change of direction in the force applied to the active wedge plate without delay, the coupling mechanism must be embodied in a substantially play-free manner. The coupling element cannot be embodied in a rigid manner. Whereas when braking in a forward direction, the forces acting upon the coupling mechanism run parallel to the connecting axis of the coupling mechanism when the coupling element is aligned parallel to the inclination of the wedge surfaces in the wedge plates, when braking in a backward direction, whereby the movement of the object to be braked occurs in a direction opposing, in relative terms, the displacement of the brake pad, transverse forces arise in the coupling mechanism which necessitate a deflection of the coupling mechanism transversely in relation to its connecting axis, in order that no destructively acting constraining forces be exerted on the connection to the actuator.

In order to satisfy the two requirements of freedom from play and allowance of a limited relative movement in a direction perpendicular to the connecting axis of the coupling mechanism, coupling mechanisms with dividing seams or slot guides are used. However, the freedom from play can only be guaranteed at high cost with high-precision slot fits or with a second motor.

Other approaches use coupling rods with two rolling or sliding bearings which have to be set so as to be free from play. Corresponding embodiments are, however, bulky and expensive and conceal, moreover, the risk that the bearings will with time deflect due to the high compressive forces acting upon the coupling rods and thereby reduce the accuracy of control of the braking force. Also, the rigidity of the arrangement is low in the case of small forces, as a result of which the quality of control of the brake proves to be relatively low even in the normal state.

Proceeding from this starting point, the object of the present invention is to indicate a coupling mechanism for an electromechanical brake, which coupling mechanism can be manufactured cost-effectively, occupies a small volume, allows a deflection perpendicular to its connecting axis but is simultaneously rigid enough in the direction of the connecting axis even under high compressive forces to guarantee a high quality of control of the brake.

This object is achieved according to the invention in the features of the independent claims.

The invention comprises a coupling device for transmitting a linear movement of a drive to a wedge plate of an electromechanical wedge brake, wherein the coupling device comprises at least one fixed-body element with a first end designed for fastening to the drive and a second end designed for connecting to the wedge plate. The fixed-body element also has a first or a plurality of first regions with a cross section whose rigidity in a first direction is substantially smaller than its rigidity in a second direction which is arranged substantially perpendicular to the first direction.

It is pointed out in this connection that the terms “comprise”, “have”, “contain” and “with”, as well as grammatical variants thereof, used in this description and in the claims for enumerating features broadly indicate the presence of features such as e.g. method steps, devices, areas, sizes and such like, but in no way exclude the presence of other or additional features or groups of other or additional features.

The invention comprises furthermore an electromechanical brake device with a drive which is designed for converting electrical energy into a mechanical linear movement, with an active wedge plate and a passive wedge plate which is connected to the electric drive in a fixed arrangement, and with one or a plurality of rolling bodies which are arranged between the active wedge plate and the passive wedge plate such that they respectively touch wedge surfaces, arranged opposite one another, of the active and the passive wedge plate. For transmitting the linear movement generated by the drive to the active wedge plate, a coupling device which has the features specified hereinabove or else further features described hereinbelow is arranged here between the drive and the active wedge plate.

The coupling device defined in the claims acts as fixed-body joint between drive and wedge plate and occupies, due to its simple structure, only a small design space. On the one hand, it provides the required great rigidity under tractive and compressive forces running axially in relation to its connecting axis and on the other it is elastic to the action of forces acting on it in a direction perpendicular to its connecting axis. The great rigidity in an axial or in a longitudinal direction of the coupling device enables here a play-free transmission of forces between drive and active wedge plate and thus a high quality of control of the electromechanical brake arrangement in which a corresponding coupling device is used.

The invention is developed further in its subclaims.

In order to increase the buckling load of the fixed-body element, the fixed-body element advantageously has a further region whose rigidity is greater in the first direction than is the rigidity of the fixed-body element in this direction in the one first region or in the plurality of first regions. In order to achieve a best possible buckling strength of the fixed-body element at minimal material cost, the further region is preferably arranged substantially centrally between the first end and the second end of the fixed-body element.

In order to prevent the occurrence of rotary movements which would lead to a play in the transmission of forces, the first end and/or the second end of the fixed-body element are usefully designed for a rotation-secure fastening or connection.

For cost-effective manufacture and to ensure a best possible rigidity of the fixed-body element, this fixed-body element is in a further embodiment preferably embodied in one piece. The fixed-body element is advantageously manufactured using punching and bending technology, which permits easy and cheap manufacture.

For a cost-effective embodiment of the electromechanical brake device using commercially available components, the drive advantageously comprises an electric motor and a gear, the gear being designed here to translate the rotary movement of the electric motor into a linear movement of a gear element. The gear can be composed of a preferably play-free spindle drive, which enables an effective translation of a rotary movement into a linear movement with low friction losses.

Further features of the invention will emerge from the description below of exemplary embodiments according to the invention in connection with the claims and the figures. The individual features indicated in the description and the claims can each be implemented in an embodiment according to the invention separately or in a plurality. In the explanation below of some exemplary embodiments of the invention, reference is made to the enclosed figures, of which:

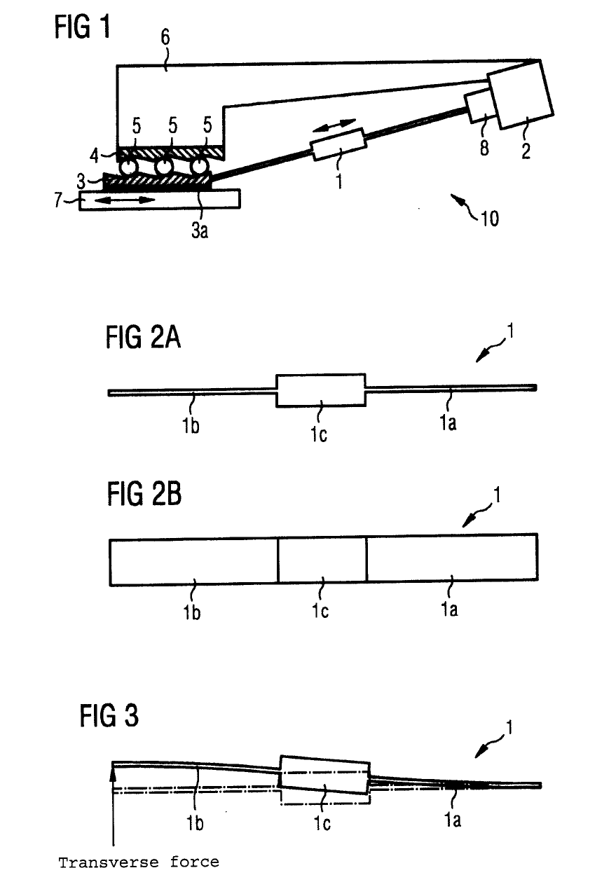

FIG. 1 illustrates in a schematic diagram which is not to scale a side view of an electromechanical wedge brake with a preferred embodiment of a coupling device,

FIG. 2a shows in a schematic diagram a side view of the coupling device from FIG. 1,

FIG. 2b shows in a schematic diagram a top view of the coupling device from FIG. 1, and

FIG. 3 illustrates the deflection of the coupling device under transverse loading.

The electromechanical brake 10 illustrated in the schematic drawing of FIG. 1 has an actuator 2 to which a gear 8 is attached for translating a rotary movement of the actuator into a linear movement. Actuator 2, for example an electric motor, and gear together form a drive for generating a linear movement for applying a force F_{M} to the brake arrangement. A coupling device 1 connects the gear 8 to an active wedge plate 3 to whose side facing the object 7 to be braked a brake lining 3a is attached. The wedge plate 3 functioning as a brake pad is supported via rolling bodies 5 on a passive wedge plate 4. The latter is fixedly connected to the actuator via a carrier device 6.

The actuator 2 is preferably composed of an electric motor, the rotary axis of which is accessible outside the housing. To translate the rotary movement of the motor axis into a linear movement, a gear 8 is the form of a spindle drive, for example a spherical threaded spindle or a roller threaded spindle, can be attached to the motor axis. Alternatively, the rotary axis of the motor outside the motor housing can itself be embodied as a spindle drive. A spindle nut is attached to the thread of the spindle in a rotationally secure and play-free manner using known techniques. A rotation of the spindle thus leads to a linear movement of the spindle nut. Instead of a spindle drive, other suitable gear types can of course also be used.

The linear movement generated via the gear 8 is transmitted via one or a plurality of coupling devices 1 to the active wedge plate 3. Wedge surfaces, against which rolling bodies 5 abut, are fashioned on the opposing surfaces of the wedge plates 3 and 4. The linear displacement of the wedge plate 3 effects a rolling of the rolling bodies on the wedge surfaces of the two wedge plates such that the gap between the two wedge plates changes. Depending on the starting position and direction of displacement of the wedge plate 3, this wedge plate is guided by the rolling movement toward or away from the object 7 to be braked. In motor vehicles, the object 7 to be braked is generally formed by a brake disk.

As a coupling device 1, there are provided one or a plurality of bar- or rod-shaped fixed-body elements which connect a linearly displaceable member of the gear 8, for example the spindle nut of a spindle drive, to the active wedge plate 3. The connection can be effected via a direct fastening of one end of the coupling device 1 to the active wedge plate 3; as an alternative to this, it can also be effected via a fastening of the end of the coupling device 1 to a part or group of parts fixedly connected to the wedge plate. The or each of the plurality of fixed-body elements 1 is for this purpose connected at one end to the linearly displaceable member of the gear 8 or to a part or a group of parts fastened thereto. At the opposite end in its longitudinal direction, the fixed-body element is fastened to the active wedge plate 3 or to a holder rigidly connected thereto. The fastenings are at both ends usefully embodied in a bend-resistant and rotationally secure manner. The fastening here can usefully be embodied in a form-locking, material-locking or force-locking manner.

In order to enable a deflection of the fixed-body elements in a direction perpendicular to their longitudinal direction, these fixed-body elements have a cross-sectional geometry whose rigidity in a first direction is substantially smaller than in a second direction arranged substantially perpendicular thereto. Thus, the fixed-body elements have a planar structure, as a result of which these fixed-body elements can be bent in this first direction in a similar manner to a leaf spring. In the other directions, by contrast, the geometry guarantees a high bending resistance of the structure.

Outlined in FIGS. 2a and 2b is an example of a fixed-body element 1 which satisfies these requirements. FIG. 2a shows the fixed-body element in a schematized side view and FIG. 2b in a schematized top view.

The fixed-body element 1 shown in the figures is composed of a planar, cuboid-shaped basic body and a thickening 1c arranged in the region of the center thereof. The thickening 1c is not a necessary integral part of the fixed-body element, but it improves, as will be explained in greater detail further below, the buckling resistance of the coupling device 1. Instead of the cuboid-shaped geometry shown, other elongate structures of a planar design can, of course, also be used as fixed-body elements 1.

The design of the coupling device as a planar, bar- or rod-shaped solid body, the ends of which are rigidly connected to a linearly displaceable member of the gear 8 and the active wedge plate 3, guarantees the required play-free transmission of a linear movement from the gear 8 to the wedge plate 3.

In a forward braking situation, the wedge plate 3 is guided in the direction of movement of and to the object 7 to be braked. During forward braking in motor vehicles, compressive forces F_{M} with values in the order of approximately 10 kN and possibly even more have sometimes to be applied to the active wedge plate 3. If these compressive forces have a component perpendicular to the longitudinal direction of the fixed-body element 1, then the fixed-body elements 1 may possible fail as a result of buckling.

Apart from the fact that, by using a plurality of fixed-body elements 1 in the coupling device, the load can be distributed and thus turn out to be lower for each element, the occurrence of corresponding transverse forces can be excluded, in that the longitudinal direction of the fixed-body elements 1, which runs along the connecting axis between the fastening to the linearly displaceable member of the gear 8 and the fastening to the active wedge plate 3, is arranged parallel to the inclination of the wedge surfaces on which the rolling bodies 5 roll during forward braking.

Compressive forces arise only at friction coefficients μ of less than tan α. If the critical value of μ=tan α is exceeded, then the fixed-body elements 1 are loaded by tractive forces. No structurally damaging buckling loads can arise in this case so that apart from adequate strength of the fixed-body elements 1, no particular design features have to be taken into account.

In a reverse braking situation, different conditions apply compared with the forward braking situation. Here, the wedge plate is guided as it approaches the object 7 to be braked against the direction of movement thereof. In this movement direction, the wedge plate has a movement component perpendicular to the longitudinal direction of the fixed-body elements 1. The fixed-body elements 1 are therefore usefully arranged such that the direction of these movement components points substantially perpendicular to the wide side of the fixed-body elements in the direction of their smallest lateral extension, and the fixed-body elements 1 can consequently easily be bent over their narrow side and yield to the movement like a fixed-body joint. The bending is effected such that the narrow sides of the fixed-body elements 1 are curved.

As already alluded to, during a forward and a reverse braking situation, high compressive forces occur along the longitudinal direction of the fixed-body elements. Under the action of these compressive forces, bending moments on the fixed-body elements 1 can arise, which bending moments lead to a loss of stability of these elements. The loss of stability is expressed in that upward of a defined load, designated the buckling load, a change of shape, which rapidly increases with the load, of the fixed-body elements 1 occurs. According to Leonard Euler (1707-1783) the buckling force of a rod or a bar of length 1 can be represented by the equation

F_{K}=n²EI/(β1)² (3)

where E represents the modulus of elasticity of the rod or bar, I the area moment of inertia of its cross section and β the buckling length coefficient. The value of the latter depends on how the ends of the rod or bar are supported. It can be seen from equation (3) that the buckling force, i.e. the compressive force required to buckle the structure decreases proportionally to the square of the length 1 of the structure.

In order to raise the buckling load for a given length, the area moment of inertia I of the rod or bar cross section can be increased in accordance with equation (3), as the area moment of inertia constitutes a measure of the resistance of a cross section to bending. The area moment of inertia increases with increasing cross-sectional area.

The geometry of the fixed-body element 1 represented in the figures makes use of the finding that an increase in cross section is required only where the greatest bending moment is to be expected. In the case of a rod- or bar-shaped structure clamped at both ends, the greatest bending moment occurs in the center. To raise the buckling load, the cross section does not therefore necessarily have to be increased over the entire length of a fixed-body element. It suffices to thicken the structure of the fixed-body elements 1 in the center of their longitudinal extent, as is illustrated by way of example in the fixed-body element 1 represented in FIGS. 2a and 2b.

Located in the center of the element represented is a cuboid-shaped structure 1c with the same width but a substantially greater thickness than the planar basic structure of the fixed-body element exhibits. The width of the structure can, however, also be embodied so as to be smaller or larger than that of the basic structure. Other thickenings, e.g. lens-shaped, elongate lens-shaped, cylindrical or such like geometries, are also possible. The thickenings, whether embodied in solid or hollow bodies, serve to increase the area moment of inertia and thus form a greater resistance to bending, whereby an increased rigidity of the fixed-body elements is achieved in the region around the center of the respective fixed-body element.

In this way, the fixed-body elements 1 are subdivided into three segments, the outer two regions being designed so as to be flexible in one direction and the central region bend-resistant. Each of the two outer regions is shorter than half the length of a fixed-body element 1 so that the thickening in accordance with equation (3) brings about an increase in the buckling load of greater than a factor of 4.

The bend-resistant region does not, however, prevent deflection of the fixed-body element 1 in a reverse braking situation. This is illustrated in FIG. 3, in which the fixed-body element deflected under the action of a transverse force (solid line) is represented in comparison with the undeflected fixed-body element (dashed line). In the case of the transverse load arising here, it is essentially the outer regions of the fixed-body element 1, which for this purpose are embodied so as to be narrow, i.e. with low rigidity to the action of the transverse force, which bend. The central region essentially retains its shape, does not, however, prevent deflection of the two ends relative to one another but supports them in that, like a lever, it connects the inner ends of the outer regions to one another in a direction-maintaining manner.

The proposed coupling device 1 embodied as a fixed-body element offers a buckling-resistant and flexible connection from an actuator or a gear attached thereto to an active wedge plate of an electromechanical wedge brake. For cost-effective manufacture, the fixed-body element is embodied in one piece, with punching and bending technology, in particular, allowing easy and cheap manufacture.

### LIST OF REFERENCE CHARACTERS

1 coupling device
1a outer region of the fixed-body element with first end
1b outer region of the fixed-body element with second end
1c further region of the fixed-body element with thickened cross section
2 actuator
3 active wedge plate
4 passive wedge plate
5 rolling body
6 carrier device
7 object to be braked, brake disk
8 device for translating the rotary movement of the actuator
10 electromechanical brake

1. A coupling device for transmitting a linear movement of a drive to a wedge plate of an electromechanical wedge brake, wherein the coupling device comprises at least one fixed-body element with a first end designed for connecting to the drive and a second end designed for connecting to the wedge plate, and the fixed-body element has a first or a plurality of first regions with a cross section whose rigidity in a first direction is substantially smaller than its rigidity in a second direction which is arranged substantially perpendicular to the first direction.

2. The coupling device according to claim 1, wherein
the fixed-body element has a further region whose rigidity in the first direction is greater than the rigidity of the fixed-body element in this direction in the one first region or in the plurality of first regions.

3. The coupling device according to claim 2, wherein
the further region is arranged substantially centrally between the first end and the second end of the fixed-body element.

4. The coupling device according to claim 1 wherein
at least on of the first end and the second end of the fixed-body element is operable to fasten or connect in a rotationally secure manner.

5. The coupling device according to claim 1, wherein
the fixed-body element is embodied in one piece.

6. The coupling device according to claim 1, wherein
the fixed-body element is manufactured using punching and bending technology.

7. An electromechanical brake device comprising
a drive which is designed for converting electrical energy into a mechanical linear movement,
an active wedge plate,
a passive wedge plate which is connected to the electrical drive in a fixed arrangement,
one or a plurality of rolling bodies which are arranged between the active wedge plate and the passive wedge plate such that they respectively touch wedge surfaces, arranged opposite one another, of the active and the passive wedge plate, and
a coupling device for transmitting a linear movement generated by the drive to the active wedge plate, wherein the coupling device comprises at least one fixed-body element with a first end designed for connecting to the drive and a second end designed for connecting to the wedge plate, and the fixed-body element has a first or a plurality of first regions with a cross section whose rigidity in a first direction is substantially smaller than its rigidity in a second direction which is arranged substantially perpendicular to the first direction, wherein the coupling device is arranged between the drive and the active wedge plate.

8. The electromechanical brake device according to claim 7, wherein
the drive comprises an electric motor and a gear, wherein the gear is designed for translating the rotary movement of the electric motor into a linear movement of a gear element.

9. The electromechanical brake device according to claim 8, wherein
the gear is composed of a spindle drive.

10. The electromechanical brake device according to claim 9, wherein
the spindle drive is designed so as to be substantially play-free.

11. The electromechanical brake device according to claim 7, wherein the fixed-body element has a further region whose rigidity in the first direction is greater than the rigidity of the fixed-body element in this direction in the one first region or in the plurality of first regions.

12. The electromechanical brake device according to claim 11, wherein the further region is arranged substantially centrally between the first end and the second end of the fixed-body element.

13. The electromechanical brake device according to claim 7, wherein at least on of the first end and the second end of the fixed-body element is operable to fasten or connect in a rotationally secure manner.

14. The electromechanical brake device according to claim 7, wherein the fixed-body element is embodied in one piece.

15. The electromechanical brake device according to claim 7, wherein the fixed-body element is manufactured using punching and bending technology.
